(19) United States
(12) Patent Application Publication
(10) Pub. No.: US 2024/0098521 A1
(43) Pub. Date: Mar. 21, 2024

(54) UNIFIED BEAM INDICATION FRAMEWORK FOR USING MULTIPLE TRANSMISSION-RECEPTION POINTS

(71) Applicant: ZTE Corporation, Shenzhen (CN)

(72) Inventors: Bo GAO, Shenzhen (CN); Zhaohua LU, Shenzhen (CN); Ke YAO, Shenzhen (CN); Yang ZHANG, Shenzhen (CN); Ling YANG, Shenzhen (CN); Xiaolong GUO, Shenzhen (CN)

(21) Appl. No.: 18/522,017

(22) Filed: Nov. 28, 2023

Related U.S. Application Data
(63) Continuation of application No. PCT/CN2022/110694, filed on Aug. 5, 2022.

(51) Int. Cl. H04W 16/28; H04B 7/06; H04W 72/1268; H04W 72/231

(52) U.S. Cl. CPC H04W 16/28; H04B 7/06952; H04W 72/1268; H04W 72/231

(57) ABSTRACT

Disclosed are techniques for providing a unified beam indication framework using multiple transmission-reception points. The techniques are performed by the disclosed apparatuses, systems, methods, and computer readable media. In one aspect, a method of wireless communication is disclosed. The method includes receiving, at a wireless device, an indication of a plurality of beam states. The method further includes performing, using the indication, a communication operation by the wireless device. In another aspect, another method of wireless communication is disclosed. The method includes transmitting, from a network node, an indication of a plurality of beam states, wherein a wireless device performs, using the indication, a communication operation.

### CROSS-REFERENCE TO RELATED APPLICATIONS

This application is a continuation of International Patent Application No. PCT/CN2022/110694, filed on Aug. 5, 2022, the contents of which are incorporated herein by reference in their entirety.

### TECHNICAL FIELD

This patent document is directed to wireless communications.

### BACKGROUND

Some wireless systems including the 5G new radio (NR) utilize single transmission-reception points (TRP) transmission and multi-TRP transmission with non-coherent joint transmission (NC-JT). Multi-TRP (mTRP) can result in some performance gains over single TRP transmission, especially for cell-edge wireless devices. The benefits of NC-JT may be limited for average throughput improvement compared with coherent joint transmission (CJT) and single frequency networks (SFNs). New techniques are needed to efficiently indicate beams for mTRP operation.

### SUMMARY

Disclosed are techniques for providing a unified beam indication framework using multiple transmission-reception points. The techniques are performed by the disclosed apparatuses, systems, methods, and computer readable media. In one aspect, a method of wireless communication is disclosed. The method includes receiving, at a wireless device, an indication of a plurality of beam states. The method further includes performing, using the indication, a communication operation by the wireless device.

In another aspect, another method of wireless communication is disclosed. The method includes transmitting, from a network node, an indication of a plurality of beam states, wherein a wireless device performs, using the indication, a communication operation.

### BRIEF DESCRIPTION OF THE DRAWINGS

FIG. 1 shows an example diagram of beam based uplink/downlink transmission with a selected Tx/Rx beam for transmission;

FIG. 2 shows an example diagram of multi-transmission-reception point (TRP) based transmission for serving a wireless device in a dynamic TRP selection (e.g., for inter-cell beam management) or joint transmission (JT) system;

FIG. 3 is an example diagram showing the activation and the indication of a joint beam state and downlink (DL) and uplink (UL) beam states;

FIG. 4 is an example diagram showing an explicit association and an implicit association for unified TCI in a multi-TRP system;

FIG. 5 shows an example QCL determination for a beam state applied to a DL channel in coherent joint transmission (CJT) or a single frequency network (SFN);

FIG. 6 shows an example QCL determination for a DL channel/RS with a scheduling/triggering offset less than a threshold value;

FIG. 7 shows an example of a process;

FIG. 8 shows another example of a process;

FIG. 9 shows an example of a system; and

FIG. 10 shows an example of an apparatus.

### DETAILED DESCRIPTION

Section headings are used in the present document to improve readability and do not limit scope of the disclosed embodiments and techniques in each section to only that section. Certain features are described using 3GPP terminology but may be practices in other wireless systems that use other wireless communication protocols.

Some wireless systems including the 5G new radio (NR) utilize single transmission-reception points (TRP) transmission and multi-TRP transmission with non-coherent joint transmission (NC-JT). Multi-TRP can result in some performance gains over single TRP transmission, especially for cell-edge wireless devices. With the advantage of low-implementation complexity, the benefits of NC-JT may be limited for average throughput improvement compared with coherent joint transmission (CJT) and single frequency networks (SFNs).

In a unified transmission configuration indicator (TCI) framework, all channels and reference signals (RSs), including physical downlink control channel (PDCCH), physical data shared channel (PDSCH), channel state information reference signal (CSI-RS), physical uplink control channel (PUCCH), physical uplink shared channel (PUSCH) and sounding reference signal (SRS), can be associated with a single TCI state/beam (also called as beam state herein). This feature is just applied to STRP case in NR 5G, and so extension of this application to mTRP case, especially for CJT and SFN, becomes very urgent. Therefore, in order to having efficient beam indication for mTRP operation, involving mTRP operation and dynamic point selection (DPS), this emerging technique of unified TCI indication should be considered. In accordance with some example embodiments, the following issues are addressed:
1) For facilitating mTRP operation, the association between one of indicated TCI states (that is applied for a long time period) and a given RSs or channels should be specified. For instance, the association comprises explicit manner (e.g., by an association parameter (e.g., a flag) configured per channel/RS to indicate which one or more TCI states from the indicated ones) or implicit (e.g., TCI state is associated with a transmission parameter or a channel, and then the transmission parameter or channel is associated with channel/RS).
2) After that, in order to support unified TCI framework for CJT and SFN, we need to consider the mechanism of combining one or more TCI states for determining QCL assumption or spatial relation of a single DMRS port/port group. Then, once having more than one TCI states, the QCL Type or determining one of the TCI states should be fully studied due to the fact that the TRP(s) should be assumed as synchronization or quasi-synchronization in CJT and SFN.
3) For a UE just supporting one indicated beam/TCI state in a band, for obtaining diversity gain, dynamic TRP selection or inter-cell beam management should be considered. Besides for mechanism of beam/TCI state indication, default beam and rules for beam collision cross different CCs in a band should be fully considered.

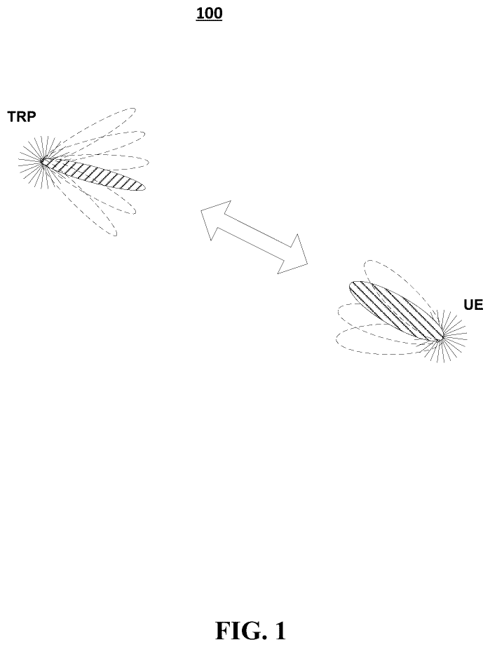

As the expense of wide or ultra-wide spectrum resources, the considerable propagation loss induced by the extremely high frequency becomes a noticeable challenge. To solve this, antenna array and beam-forming training technologies using massive MIMO, e.g., up to 1024 antenna elements for one node, have been adopted to achieve beam alignment and obtain sufficiently high antenna gain. FIG. 1 shows an example of beam based UL/DL transmission, where the shaded portion represents the selected Tx/Rx beam for transmission. To keep low implementation cost while still benefit from antenna array, analog phase shifters become very attractive for implementing millimeterwave (mmWave) beamforming, which means that the number of controllable phases is finite and the constant modulus constraints are placed on these antenna elements. Given the pre-specified beam patterns, the variable-phase-shift-based BF training targets to identify the best pattern for subsequent data transmission generally, e.g., between one TRP and one UE panel.

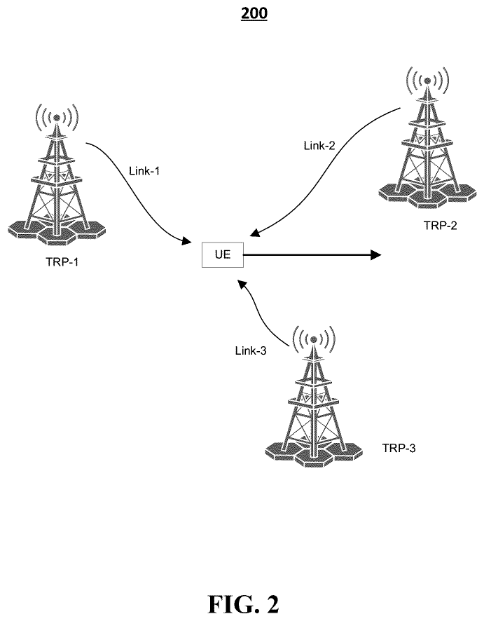

Then, as the expense of wide or ultra-wide spectrum resources and massive or large-massive MIMO in a single TRP site, multi-TRP operation should be considered as an emerging technique for balancing the deployment cost and throughput/robustness. As shown in FIG. 2, an example diagram showing multi-TRP based transmission for serving a single UE in dynamic TRP selection (e.g., for inter-cell beam management) or joint transmission (JT). In such case, especially for FDD or cell-edge UE in TDD, CSI information (involving PMI, RI, CQI, etc.) for determining DL precoding should be reported from UE to gNB, and even for a single layer (or a DMRS port) the precoding is provided for Tx antennas across multi-TRP accordingly.

### Examples

As used herein, a “beam state” is equivalent to quasi-co-location (QCL) state, transmission configuration indicator (TCI) state, spatial relation (also called as spatial relation information), reference signal (RS), spatial filter or pre-coding. As used herein, a “beam state” is also a “beam”. Note that, as used herein, spatial relation is equivalent to spatial filter.

A “Tx beam” is equivalent to QCL state, TCI state, spatial relation state, DL/UL reference signal (such as channel state information reference signal (CSI-RS), synchronization signal block (SSB) (which is also called as SS/PBCH), demodulation reference signal (DMRS), sounding reference signal (SRS), and physical random access channel (PRACH)), Tx spatial filter or Tx precoding.

A “Rx beam” is equivalent to QCL state, TCI state, spatial relation state, spatial filter, Rx spatial filter or Rx precoding.

A “beam ID” is equivalent to QCL state index, TCI state index, spatial relation state index, reference signal index, spatial filter index or precoding index.

The spatial filter can be either UE-side or gNB-side one, and the spatial filter is also called as spatial-domain filter or spatial relation.

Note that a “spatial relation information” can be comprised of one or more reference RSs, which is used to represent the same or quasi-co spatial filter between targeted “RS or channel” and the one or more reference RSs.

Note that a “beam state” can be associated with or comprised of, one or more reference RSs and/or their corresponding QCL type parameters, where QCL type parameters include at least one of the following aspect or combination: [1] Doppler spread, [2] Doppler shift, [3] delay spread, [4] average delay, [5] average gain, and [6] Spatial parameter. As used herein, a “TCI state” is equivalent to “beam state”. As used herein, a ‘spatial parameter’ is equivalent to spatial parameter, spatial Rx parameter or spatial filter. Note the following example definitions for ‘QCL-TypeA’, ‘QCL-TypeB’, ‘QCL-TypeC’, and ‘QCL-TypeD’.
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

Note that a “UL channel” can be PUCCH or PUSCH.

Note that a “DL channel” can be PDCCH, or PDSCH.

Note that a “UL RS” can be SRS, PRACH, DMRS (e.g., DMRS for PUSCH or PUCCH).

Note that a “DL RS” can be SSB, CSI-RS, DMRS (e.g., DMRS for PDSCH, or PDCCH).

Note that a “UL signal” can be UL channel or UL RS (e.g., SRS, PRACH, DMRS, PUSCH or PUCCH).

Note that a “DL signal” can be DL channel or DL RS (SSB, CSI-RS, DMRS, PDSCH, or PDCCH).

Note that a “time unit” can be sub-symbol, symbol, slot, sub-frame, frame, or transmission occasion.

Note that power control parameter can include target power (also called as P0), path loss RS, scaling factor for path loss (also called as alpha), or closed loop process. As used herein, the path-loss can be a coupling loss.

Note that a “DCI” is equivalent to “PDCCH”. Note that ‘PDCCH’ includes at least one of a CORESET or a search space set. Note that ‘scheduling offset’ is equivalent to ‘triggering offset’.

Note that a ‘precoding information’ is equivalent to a PMI, TPMI, precoding or beam.

Note that a ‘TRP’ is equivalent to a RS port, a RS port group, RS resource, or a RS resource set.

Note that a ‘port group’ is equivalent to antenna group, or UE port group.

Note that a group information parameter includes at least one of PCI, CORESET group information, CORESET pool ID, UE capability value set, port group, RS or RS set.

### Example 1: General Description for Unified TCI Framework for mTRP

Generally, for unified TCI framework for mTRP operation, one or more beam states (e.g., TCI state) can be indicated by a first command (e.g., DCI or a MAC-CE command) for determining QCL assumption of a DL signal, or spatial relation and power control parameters for a UL signal. For the first command, we have the following clarification:
In MAC level, if the activation command (i.e., a MAC-CE command) maps beam state(s) to only one codepoint, and then the beam state is applied directly. In such case, the first command is equivalent to the MAC-CE command;
Otherwise, if the activation command (i.e., a MAC-CE command) maps beam state to more than one codepoint, a DCI command is to indicate one of multiple codepoints activated in the activation command for determining QCL assumption of a DL signal, or spatial relation and power control parameters for a UL signal. In such case, the first command is equivalent to the DCI command.

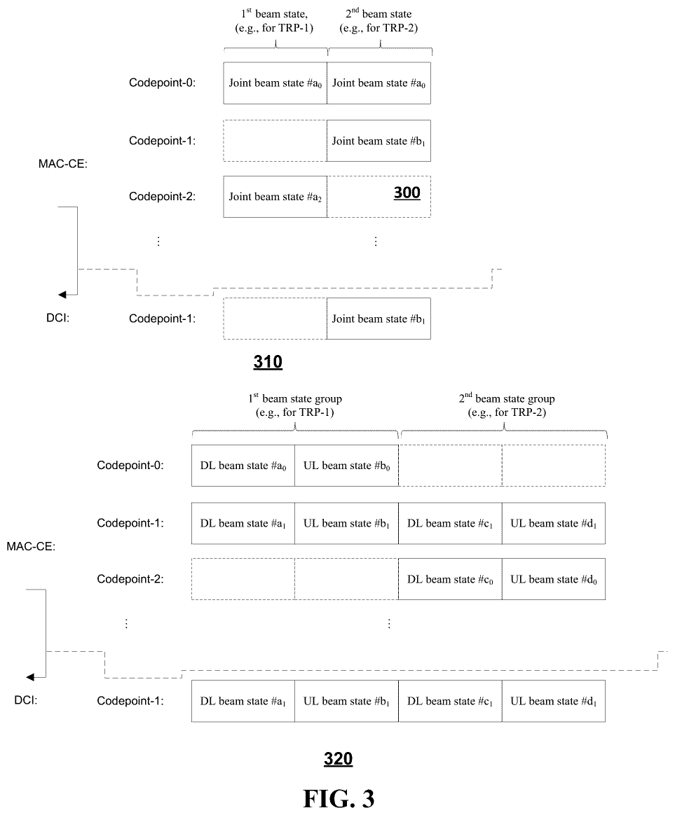

One example for beam state configuration/activation for a codepoint is shown in FIG. 3.
In FIG. 3, the example is to depict the diagram for joint beam state (e.g., a RRC parameter DLorJointTCIState) activation and indication. Then, the first beam state corresponds to TRP-1 and second beam state corresponds to TRP-2, e.g., for single-DCI mTRP case.
In FIG. 3, the diagram for separate TCI indication (e.g., DL/joint and UL TCI state, like DLorJointTCIState and TCIState) is provided. Compared with the FIG. 3, we can observe that one beam state group corresponds to a TRP.
   Note that even for joint TCI state, in order to accommodate more than one TCI state(s) for a single channel (e.g., PDCCH), a beam state group including more than 1 joint beam states may be applied to the single channel.
   For saving RRC signaling overhead, considering that joint TCI state and separate TCI state does not need to be configured together, joint TCI state and DL TCI state use the same RRC parameter, i.e., DLorJointTCIState.

Generally speaking, if there may be more than one beam states indicated by the first command, and some or all of them may be applied to a given DL or UL signals. The association between one of beam states and the given DL or UL signals should be determined by the UE.
Option-1 (Explicit manner): an association parameter (e.g., flag) is configured per DL or UL signals to indicate which one or more of beam states indicated by the first command is applied to the DL or UL signal. In other words, the beam states applied to a given DL or UL signal are determined according to the association parameter.
   Furthermore, for a DL signal, the beam state comprises a DL beam state or a joint beam state (e.g., applied to both DL and UL), e.g., DLorJointTCIState.
   Furthermore, for a UL signal, the beam state comprises a UL beam state or a joint beam state, e.g., UL-TCIState or DLorJointTCIState.
   The candidate values for the association parameter comprises at least one of: none, a first beam state, a second beam state, both first and second beam states, a i-th beam state, all beam states in a codepoint, a first beam state group, a second beam state group, both first and second beam state groups, a i-th beam state group, all beam state groups in a codepoint. Herein, i denotes an integer.
      Furthermore, the first beam state refers to a first beam state, or a beam state with a lowest ID from beam states in a codepoint;
      Furthermore, the second beam state refers to a second beam state with a highest ID or 2^{nd} lowest ID from beam states in a codepoint.
      Furthermore, the i-th beam state refers to a beam state with i-th lowest ID from the beam states in a codepoint.
         Furthermore, for a DL signal, the value of association parameter corresponds to an index corresponds to DL beam state or a joint beam state, e.g., DLorJointTCIState.
         Furthermore, for a UL signal, the value of association parameter corresponds to an index corresponds to UL beam state or a joint beam state, e.g., UL-TCIState or DLorJointTCIState.
         In order words, an index corresponding to DL beam state or a joint beam state, e.g., DLorJointTCIState, is numbered among all DL beam state or a joint beam state, e.g., DLorJointTCIState, in the codepoint.
         In order words, an index corresponding to UL beam state or a joint beam state, e.g., UL-TCIState or DLorJointTCIState, is numbered among all UL beam state and a joint beam state, e.g., UL-TCIState or DLorJointTCIState, in the codepoint.
   Furthermore, for different cases, we have the following configuration mechanism:
      For PDCCH, the association parameter (e.g., flag) is configured per CORESET or search-space (SS) set;
      For scheduled PDSCH, the association parameter is configured in the codepoint by MAC-CE or indicated in a field of the DCI scheduled the PDSCH or initiated configured-grant PDSCH.
      For first-type configured-grant PUSCH (e.g., granted by RRC), the association parameter is configured in RRC, e.g., in RRC parameter ConfiguredGrantConfig or rrc-ConfiguredUplinkGrant.
         Furthermore, the first-type configured-grant PUSCH comprises a PUSCH configured by ConfiguredGrantConfig but which is configured with RRC parameter rrc-ConfiguredUplinkGrant
      For second-type configured-grant PUSCH (e.g., initiated by the DCI), the association parameter is configured in the codepoint by MAC-CE or indicated in a field of the DCI scheduled the PUSCH.
         Furthermore, the configured-grant PUSCH comprises a PUSCH configured by ConfiguredGrantConfig but which is not configured with RRC parameter rrc-ConfiguredUplinkGrant
      For CSI-RS or SRS, the association parameter is configured in the resource set, in the resource, or is configured in the codepoint by MAC-CE or indicated in a field of a DCI (e.g., triggered the CSI-RS or SRS).
      For PUCCH, the association parameter is configured in a PUCCH resource or a PUCCH resource group.
   Furthermore, a codepoint can be associate with one or more beam state groups, and then the association parameter is to indicate which one or more of beam state groups indicated by the first command is applied to the DL or UL signal.
      In other words, the beam state groups applied to a given DL or UL signal are determined according to the association parameter.
   Furthermore, if the two or more DL or UL signals are configured with the same association parameter or is associated with the same beam state(s), the DL or UL signals should be associated with the same group information parameter. Or, in other words, if the two or more DL or UL signals should be associated with the same group information parameter, the two or more DL or UL signals are configured with the same association parameter or is associated with the same beam state(s).
      For instance, if two CORESETs are associated with the same CORESETPoolID or the same PCI, the two CORESETs should be associated with the same association parameter.
Option-2 (Implicit manner)
   TCI state is associated with a group information parameter or a channel (e.g., PDCCH in a CORESET), and then the transmission parameter or channel is associated with channel/RS. Then, the TCI is applied to the channel/RS associated with the same group or same channel (e.g., PDCCH in a CORESET) associated with the TCI.
      For instance, a PDSCH is scheduled by a PDCCH in a CORESET, and then the TCI state used in the CORESET is applied to the PDSCH.
      For instance, a group information parameter (e.g., CORESET pool ID or CORSET group information ID) is configured in a PUCCH resource, and then a TCI can be activated for a group information parameter by MAC-CE. Then, when the TCI state is indicated by the first command, the power control parameter or spatial relation of the PUCCH once being transmitted should be determined according to the TCI state with the same group information parameter as the PUCCH.
   For instance, port group comprises at least one of RS port group (e.g., CSI-RS or SRS port group) or antenna port groups.
Furthermore, one or more of plurality of beam states for the DL signal or UL signal can be selected according to an indication in the DCI or MAC-CE.
   Furthermore, the DL signal comprises a CORESET associated with CORESETPoolId.
   Furthermore, the indication is determined according to at least one of the following field in the DCI: Time domain resource assignment (TDRA) field, PDSCH-to-HARQ_feedback timing indicator field, HARQ process number field, antenna port(s) field, non-DL-data field, PUCCH resource indicator (PRI) field.
      For instance, when the HARQ process number field is to indicate which beam state (group) is updated for which CORESET, e.g., when the HARQ process number field is zero, the beam state from a MAC-CE updated pool associated with CORESETPoolId=zero is applied to DL/UL signals associated with CORESETPoolId=zero.
   Furthermore, the DCI is scrambled by CS-RNTI, or
   Furthermore, in the DCI, an RV field is set to all ‘1’s, MCS field is set to all ‘1’s, NDI field is set to 0, FDRA field is set to all ‘0’s for Type 0, FDRA is set to all ‘1’s for Type 1, or FDRA is set to all ‘1’s for dynamicSwitch. That is, the DCI is a DCI without DL assignment.

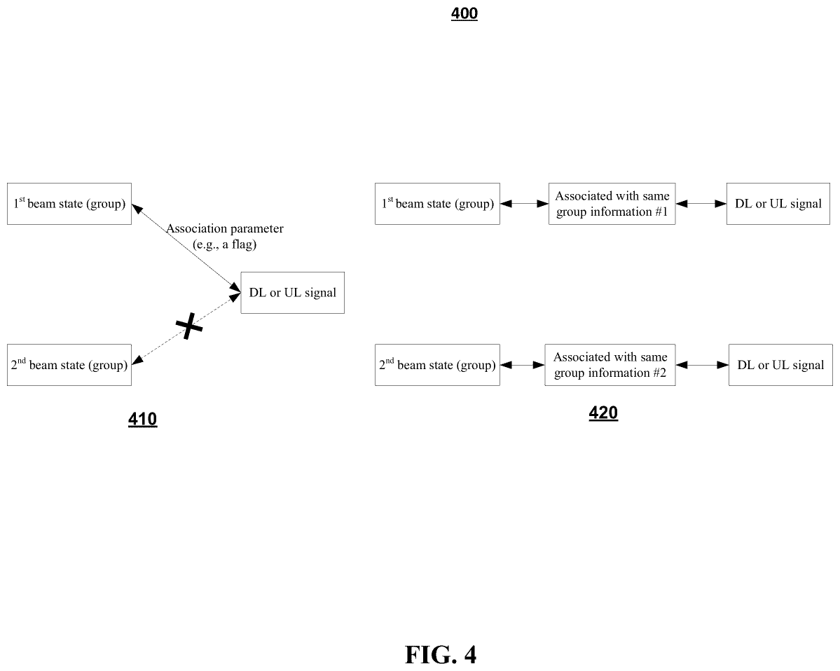

For instance, the association between one of indicated TCI states (that is applied for a long time period) and a given RSs or channels should be specified, and then the explicit and implicit manner for association can be found in FIG. 4.
In FIG. 4, for explicit association manner, association parameter is configured per DL or UL signal (e.g., for PDCCH, the association parameter is configured per CORESET). For instance, the association parameter is to indicate that the CORESET is to follow the first indicated beam state (group).
In FIG. 4, for implicit association manner, the beam state or beam state group can be associated with a group information parameter, and then the DL or UL signal can be associated with a group information parameter. So, from perspective of determining QCL assumption (for DL signal), or spatial relation and power control parameter (for UL signal), the rule is relevant to the same group information parameter.
   In other words, UE assumes that one beam state to be indicated in the first command can be only associated with a unique group information parameter.
   Furthermore, the beam states or beam state groups in the codepoint should be associated with different or respective group information parameters.

### Example 2: Beam State Indication for Coherent Joint Transmission (CJT) and SFN

In order to support unified beam state (e.g., TCI) framework for CJT and SFN, we need to consider the mechanism of combining one or more beam states for a single DMRS port/port group. Then, once having more than one beam states, the QCL Type or determining one of the TCI states should be further justified. Specifically, we have the following mechanism for CJT and SFN
One or more beam state(s) (e.g., up to 4 TCI states) can be associated with a beam codepoint, and then the all of the one or more beam state(s) can be applied to each of DMRS ports of DL or UL signals (e.g., PDSCH, PDCCH, PUCCH and PUSCH).
   Specifically, for an explicit manner as mentioned in Embodiment #1, the association parameter can contain a candidate which can be both first and second beam states (groups) or all beam states (groups) in a codepoint.
   Then, for an implicit manner, the DL or UL signal can be associated with one or more group information parameters.
   Furthermore, the above applies to both CJT and SFN cases.
Furthermore, considering the case of CJT/SFN+sDCI/mDCI-mTRP, the codepoint can be associated with one or more beam state groups.
   Each of beam state which corresponds to TRPs in a CJT mode, and TRPs corresponding to different TCI state from separate beam groups corresponds to non-coherent joint transmission (NCJT).
Due to the fact that the indicated TCI state in the first command may also apply to other RS (e.g., CSI-RS for CSI or sTRP mode, e.g., CG PUSCH transmission), the flexible mechanism for combining QCL parameter is needed. By default, the configured QCL Type in the beam state should at least comprises all of {Doppler shift, Doppler spread, average delay, delay spread}, i.e., QCL-TypeA
   Once a transmission mode is configured (e.g., for CJT or SFN), the DL channel (e.g., PDSCH or PDCCH) or DMRS of the DL channel is quasi co-located with the RSs of the one or more beam states except for quasi co-location parameters X of at least one of the one or more beam state.
      X comprises at least one of {Doppler shift}, {Doppler spread}, {average delay}, {delay spread}, {Doppler shift, Doppler spread}, {average delay, delay spread}, {Doppler shift, average delay}, or {Doppler spread, delay spread}.
      For instance, when CJT mode is configured, and when two beam states (groups) are associated with one indicated codepoint, the DMRS of PDCCH is quasi co-located with the RSs of the one or more beam states except for quasi co-location parameters X={Doppler shift, Doppler spread} of second beam state.
      For instance, when CJT mode is configured, the DMRS of PDSCH is quasi co-located with the RSs of the one or more beam states except for quasi co-location parameters X={average delay, delay spread} of second beam state.
      Furthermore, the transmission mode can be configured by RRC or MAC-CE.
      Furthermore, the quasi co-location parameters X is determined according to the transmission mode or number of TCI state or TCI state groups indicated by the first command.
         For instance, when the transmission mode is SFN, X={Doppler shift, Doppler spread}; but when then transmission is CJT, X={average delay, delay spread }.
   Furthermore, if the transmission mode is configured, quasi co-location parameters X from the beam states (indicated by first command) except for one of beam states (e.g., first beam state) in the codepoint is ignored.
   Furthermore, QCL Type of beam state can be updated or determined according to MAC-CE, wherein the QCL Type is indicated from a candidate pool.
      The candidate pool comprises at least one of {Doppler shift, Doppler spread, average delay, delay spread}, {Doppler shift}, {Doppler spread}, {average delay}, {delay spread}, {Doppler shift, Doppler spread}, {average delay, delay spread}, {Doppler shift, average delay}, or {Doppler spread, delay spread}.
   Once a transmission mode is configured (e.g., for CJT or SFN), spatial relation of the UL channel (e.g., PUCCH or PUSCH) is determined according to all or respective RS in each of one or more beam states; the power control parameter of UL channel is determined according to one power control parameter of one of one or more beam state (e.g., first one).
   For instance, spatial relation of PUCCH is determined according to RS s in each of beam state to be indicated by the first command, and then power control parameter of PUCCH is determined according to the power control parameter associated with first beam state.
   Furthermore, the first beam state corresponds to the beam state with lowest ID in a codepoint. For instance, the ID is local index in the codepoint or TCI state ID in RRC level.
   Furthermore, the first beam state group corresponds to the beam state group with lowest ID in a codepoint.

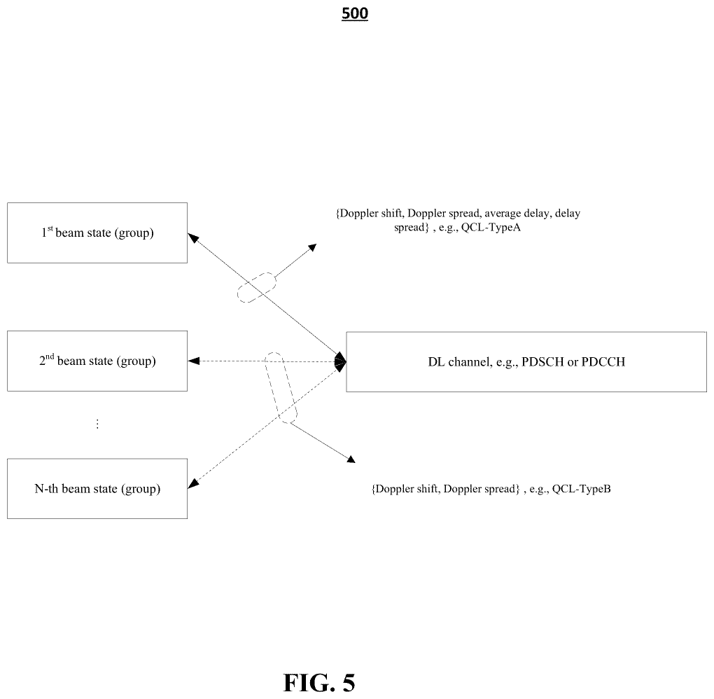

For instance, for CJT transmission, the QCL assumption of DL channel can be determined according to up to N beam states. Then the first beam states corresponds to {Doppler shift, Doppler spread, average delay, delay spread} (e.g., QCL-TypeA), and the other beam states are only relevant to {Doppler shift+Doppler spread} (e.g., QCL-TypeB). It is shown in FIG. 5.

### Example 3: Rules for Facilitating TCI for Dynamic TRP Selection or Inter-cell Beam Management

For dynamic TRP selection (e.g., dynamic point selection, DPS), the non-UE dedicated channel (i.e., PDCCH in common search space set (CSS) except for CSS Type 3, and its scheduled PDSCH) still need to be in the serving cell, but other DL or UL channel can be switched to other TRP with additional PCI from serving cell. Then for handling the default beam when scheduling offset less than a threshold, the following should be handled:
If the beam state indicated by first command is associated with PCI different from serving cell PCI (i.e., inter-cell),
   QCL assumption of PDSCH with scheduled offset less than a threshold, regardless of UE dedicated channel/RS or not, should be determined according to CORESET associated with a monitored search space with the lowest CORESET ID in the latest slot
   If the QCL-TypeD property for default beams in a slot for CCs in a band are different, the default beam for the CC with lowest ID is prioritized, i.e., the default beam for the CC with lowest ID is applied to all the CCs in a band

But, for normal case, the QCL-TypeD and QCL-TypeA RS should be correlated, e.g., a same TRS is used for both QCL-TypeA and QCL-TypeD determination.
Furthermore, QCL assumption of PDSCH with scheduled offset less than a threshold should be determined according to CORESET associated with a monitored search space with the lowest CORESET ID in the latest slot in a CC
   For multi-CC case, if the QCL assumption is different in a time unit for different CCs, QCL-TypeA assumption for a CC of a CC list or a band is determined according to at least one of the following:
      A RS in the first CC and having the same resource ID as the RS with regard to (w.r.t) QCL-TypeA in the QCL assumption of the CC with lowest ID in the CC list or a band.
      A RS in the first CC and having the same resource ID as the RS with regard to (w.r.t) QCL-TypeD in the QCL assumption of the CC with lowest ID in the CC list or a band.
   If the QCL assumption is different in a time unit (e.g., slot or OFDM symbol) for different CCs, QCL-TypeC assumption for a CC of a CC list or a band is determined according to the RS with regard to (w.r.t) QCL-TypeA in the QCL assumption of the CC with lowest ID in the CC list or a band.
Furthermore, QCL assumption of PDSCH with scheduled offset less than a threshold should be determined according to CORESET associated with a monitored search space with the lowest CORESET ID in the latest slot in a CC with lowest ID from a CC list or a band corresponding to the scheduling CC (i.e., a CC carrying the PDSCH transmission).
   Furthermore, the QCL assumption comprises QCL-TypeD
   Furthermore, for QCL-TypeA, we have the following rules:
      QCL-TypeA assumption of PDSCH with scheduled offset less than a threshold should be determined according to QCL-TypeA RS corresponding to CORESET associated with a monitored search space with the lowest CORESET ID in the latest slot in a CC with lowest ID from a CC list or a band corresponding to the scheduling CC (i.e., a CC carrying the PDSCH transmission).
         Furthermore, the QCL-TypeA assumption is determined according to a RS in the scheduling CC and having the same resource ID as the QCL-TypeA RS corresponding to CORESET.
Above rule can be apply to aperiodic CSI-RS (AP-CSI-RS) as well. For instance, QCL assumption of AP-CSI-RS with scheduled offset less than a threshold should be determined according to CORESET associated with a monitored search space with the lowest CORESET ID in the latest slot in a CC with lowest ID from a CC list or a band corresponding to the scheduling CC (i.e., a CC carrying the AP-CSI-RS transmission).

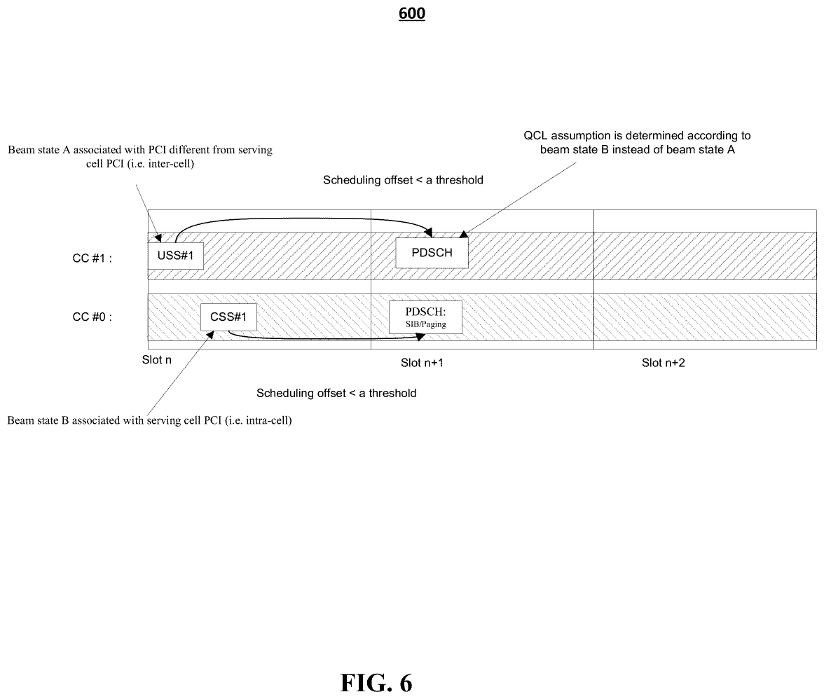

For instance, for inter-cell beam management, the UE can be activated more than one beam state but only use one beam state for DL/UL transmission. The indicated beam state by first command corresponds to a beam state (e.g., beam state-A) associated with PCI different from serving cell PCI, and then QCL assumption for the PDSCH with scheduling offset<a threshold should be determined according to the CORESET with lowest ID in its own CC. Then, if the QCL-TypeD assumptions for different CCs in this case in a given time unit are different as shown in FIG. 6 (e.g., a threshold for scheduling offset is 24 OFDM symbols), QCL-TypeD of the PDSCH with scheduling offset<a threshold should be determined according to the QCL-TypeD of the CORSET with lowest ID in the CC with lowest ID in the CC list or a band.
Furthermore, the QCL-TypeA assumption should be updated accordingly, i.e., still in the serving CC but a RS with a same resource ID as the RS with regard to (w.r.t) QCL-TypeA of the CORSET with lowest ID in the CC with lowest ID in the CC list or a band.

In this disclosure, the framework for unified TCI indication for facilitating mTRP operation, involving association between one of indicated TCI states and a given RS s or channels, is proposed. Then, for CJT and SFN, mechanisms of combining one or more TCI states for a single DMRS port/port group and determining corresponding QCL Types are described accordingly. After that, rules for beam collision for PDSCH/AP-CSI-RS with scheduling/triggering offset<a threshold cross different CCs in a band should be additionally considered for inter-cell beam management (i.e., dynamic TRP selection).

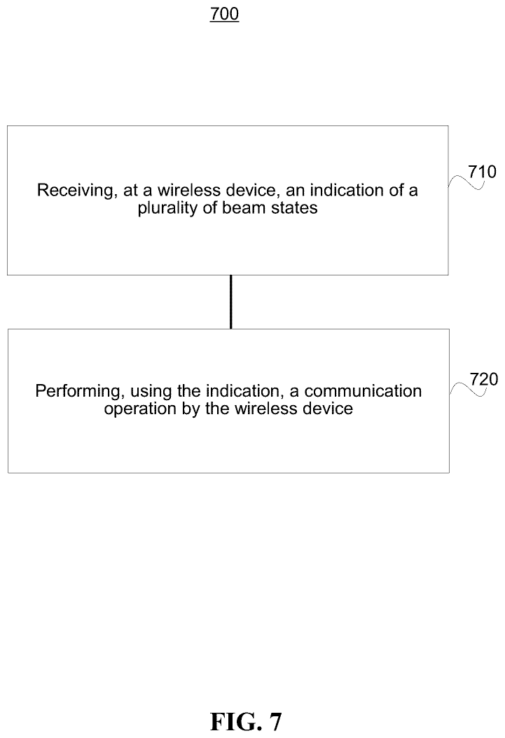

FIG. 7 depicts an example of a method of wireless communication 700, in accordance with some example embodiments. At 710, the method includes receiving, at a wireless device, an indication of a plurality of beam states. At 720, the method includes performing, using the indication, a communication operation by the wireless device.

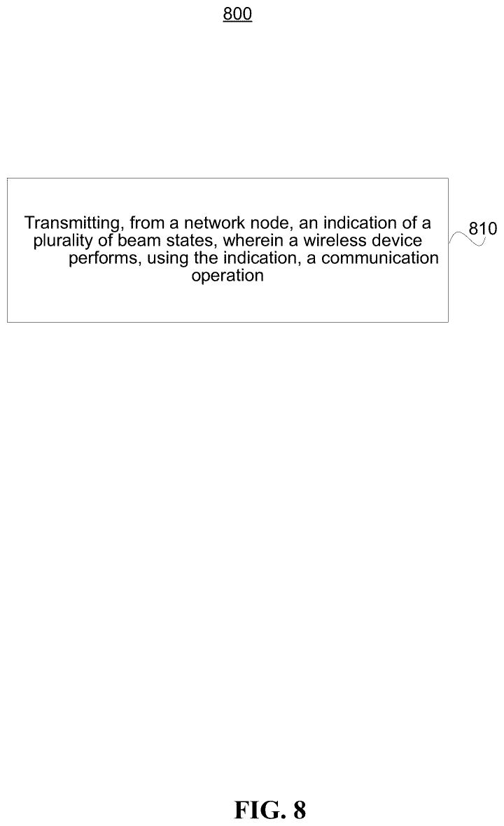

FIG. 8 depicts an example of a method of wireless communication 800, in accordance with some example embodiments. At 810, transmitting, from a network node, an indication of a plurality of beam states, wherein a wireless device performs, using the indication, a communication operation.

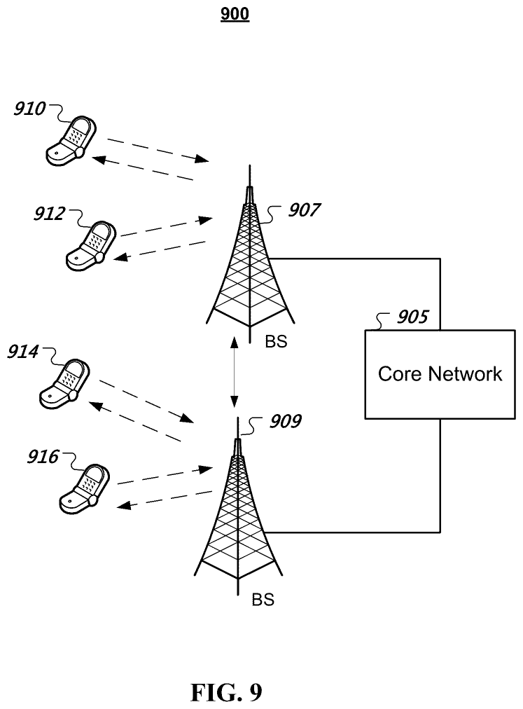

FIG. 9 shows an example of a wireless communication system (e.g., a 5G or NR cellular network) that includes one or more base stations 907, 909 and one or more user equipment (UE) 910, 912, 914 and 916. In some embodiments, the UEs access the BS and core network 805 (e.g., the network) using a communication link to the network (sometimes called uplink direction, as depicted by dashed arrows pointing toward a base station), which then enables subsequent communication. In some embodiments, the BS sends information to the UEs (sometimes called downlink direction, as depicted by arrows from the base stations to the UEs), which then enables subsequent communication between the UEs and the BSs, shown by dashed arrows between the UEs and the BSs.

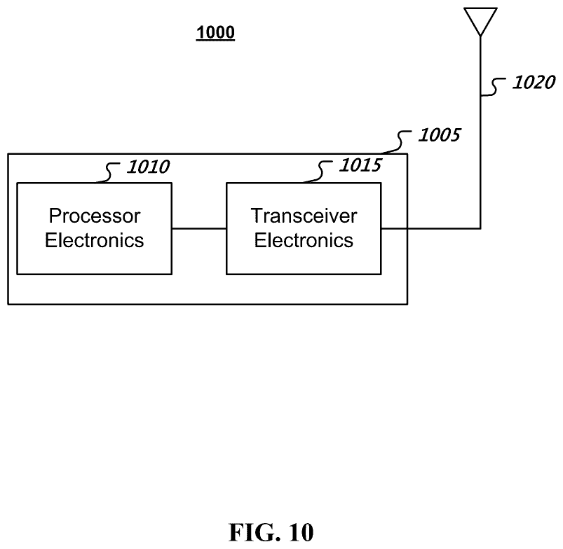

FIG. 10 shows an exemplary block diagram of a hardware platform 1000 that may be a part of a network node (e.g., base station) or a communication device (e.g., a wireless device such as a user equipment (UE)). The hardware platform 1000 includes at least one processor 1010 and a memory 1005 having instructions stored thereupon. The instructions upon execution by the processor 1010 configure the hardware platform 1000 to perform the operations described in FIGS. 1 to 9 in the various embodiments described in this patent document. The transceiver 1015 transmits or sends information or data to another device. For example, a wireless device transmitter as part of transceiver 1015 can send a message to a user equipment via antenna 1020. The transceiver 1015 receives information or data transmitted or sent by another device via antenna 1020. For example, a wireless device receiver as part of transceiver 1015 can receive a message from a network device via antenna 1020.

The following clauses reflect features of some preferred embodiments.

Clause 1. A method of wireless communication, comprising: receiving, at a wireless device, an indication of a plurality of beam states; and performing, using the indication, a communication operation by the wireless device.

Clause 2. The method of clause 1, wherein the communication operation comprises receiving a downlink (DL) signal from a network device, and wherein one or more of the plurality of beam states is used for determining a quasi-colocation (QCL) assumption for the DL signal.

Clause 3. The method of clauses 1 or 2, wherein the communication operation comprises determining a spatial filter or a power control parameter for an uplink (UL) signal from the wireless device to the network device according to one or more of the plurality of beam states.

Clause 4. The method of clauses 1, 2, or 3, further comprising: configuring an association parameter, for the DL signal or the UL signal, to select the one or more of the plurality of beam states; or selecting one or more of plurality of beam states for the DL signal or UL signal according to another indication in the DCI or MAC-CE.

Clause 5. The method of clause 4, wherein a group information parameter is determined according to the other indication, and the DL signal or UL signal is associated with a same group information parameter with the one or more plurality of beam states, the DL signal comprises a CORESET associated with CORESETPoolId, the other indication is determined according to at least one of the following field in the DCI: Time domain resource assignment (TDRA) field, PDSCH-to-HARQ_feedback timing indicator field, HARQ process number field, antenna port(s) field, non-DL-data field, PUCCH resource indicator (PRI) field, the DCI is scrambled by CS-RNTI, or in the DCI, an RV field is set to all ‘1’s, MCS field is set to all ‘1’s, NDI field is set to 0, FDRA field is set to all ‘0’s for Type 0, FDRA is set to all ‘1’s for Type 1, or FDRA is set to all ‘1’s for dynamicSwitch.

Clause 6. The method of wireless communication of clause 1, wherein at least one of the plurality of beam states comprises one or more transmission configuration indicators (TCIs).

Clause 7. The method of wireless communication of clause 1, wherein the indication comprises downlink control information (DCI) command or a media access control element (MAC-CE) command.

Clause 8. The method of wireless communication of clause 4, wherein in a case of configuring an association parameter per the DL signal, the selected one or more of the plurality of beam states comprises a downlink beam state or a joint beam state.

Clause 9. The method of wireless communication of clause 4, wherein in a case configuring an association parameter per the UL signal, the selected one or more of the plurality of beam states comprises an uplink beam state or a joint beam state.

Clause 10. The method of wireless communication of clause 4, wherein each association parameter includes at least one of: no beam state, a first beam state, a second beam state, both the first beam state and the second beam states, an i-th beam state, all beam states in a codepoint, a first beam state group, a second beam state group, both the first beam state group and the second beam state group, a j-th beam state group, all beam state groups in a codepoint, wherein i and j are integers.

Clause 11. The method of wireless communication of clause 10, wherein the first beam state has a lowest identifier value from beam states in a codepoint, the second beam state has a highest identifier or second lowest identifier from beam states in a codepoint, the i-th beam state has a i-th lowest identifier or a i-th highest identifier from beam states in a codepoint, the first beam state group has a lowest identifier value from beam state groups in a codepoint, the second beam state group has a highest identifier or second lowest identifier from beam state groups in a codepoint, or the i-th beam state group has a i-th lowest identifier or a i-th highest identifier from beam state groups in a codepoint.

Clause 12. The method of wireless communication of clause 4, wherein the DL signal comprises a PDCCH, and wherein the association parameter is configured per CORESET or search-space (SS) set.

Clause 13. The method of wireless communication of clause 4, wherein the DL signal comprises a shared channel, and wherein the association parameter is configured in a codepoint by a MAC-CE command or indicated by a field in the DCI scheduled the shared channel or initiated configured-grant in the shared channel.

Clause 14. The method of wireless communication of clause 4, wherein the UL signal comprises a first-type configured-grant PUSCH, and wherein the association parameter is configured in a radio resource control (RRC) parameter.

Clause 15. The method of wireless communication of clause 4, wherein the UL signal comprises a second-type configured-grant PUSCH, and wherein the association parameter is configured in a codepoint by a MAC-CE command or indicated in a field of the DCI.

Clause 16. The method of wireless communication of clause 4, wherein the DL signal comprises a CSI-RS, or the UL signal comprises a sounding reference signal (SRS), and wherein the association parameter is configured in a resource set or is configured in a codepoint by a MAC-CE command or indicated in a field of a DCI.

Clause 17. The method of wireless communication of clause 16, wherein the DL signal or UL signal is triggered by the DCI.

Clause 18. The method of wireless communication of clause 4, wherein the UL signal comprises a PUCCH, and wherein the association parameter is configured in a PUCCH resource or a PUCCH resource group.

Clause 19. The method of wireless communication of clause 4, wherein the plurality of beam states comprises one or more beam state groups, wherein the one or more beam state groups is associated with a codepoint, and wherein the association parameter indicates which of the one or more beam state groups is applied to the DL or UL signal.

Clause 20. The method of wireless communication of clause 19, wherein the one or more beam state groups is associated with a codepoint.

Clause 21. The method of wireless communication of clause 4, wherein the two or more DL or UL signals are configured with a same association parameter or associated with a same beam state, and wherein the DL or UL signals are associated with a same group information parameter.

Clause 22. The method of wireless communication of clause 4, wherein the DL signal comprises the two or more CORESETs, wherein the CORESETs are configured with a same association parameter or associated with a same CORESETPoolId or a same physical cell identity (PCI), and wherein the two or more CORESETs are associated with a same group information parameter.

Clause 23. The method of clauses 1-3, further comprising: associating a group information parameter with one or more of the plurality of beam states; associating a group information parameter with the DL or UL signals, wherein the one or more beam states is applied to DL or UL signals associated with the same group information parameter as the one or more beam states.

Clause 24. The method of wireless communication of clause 23, wherein one beam state indicated in the indication is associated with a unique group information parameter.

Clause 25. The method of wireless communication of clause 23, wherein the plurality of beam states or beam state groups in a codepoint are associated with different or respective group information parameters.

Clause 26. The method of wireless communication of clause 2 or 3, wherein the plurality of beam states comprises at least one beam state group, wherein the one or more beam states in the beam state group are applied to the DL or UL signals, or one demodulation reference signal (DMRS) ports of the DL or UL signals.

Clause 27. The method of wireless communication of clause 26, wherein at least one of the DL or UL signals is associated with one or more group information parameters or is configured with an association parameter to select the beam state group of the plurality of beam states.

Clause 28. The method of wireless communication of any of clauses 1-27, wherein the group information parameter comprises at least one of: a physical cell identity (PCI), a CORESET group information identity, a control resource set (CORESET) pool identity, a wireless device capability value set, a port group, an RS, or an RS set.

Clause 29. The method of wireless communication of clause 26, wherein the DL signal comprises a DL channel, wherein when a transmission mode is configured, the DL channel or DMRS of the DL channel is quasi co-located with RSs of the one or more beam states except for one or more quasi co-location parameters of at least a first beam state of the one or more beam states.

Clause 30. The method of wireless communication of claim 26, wherein a transmission mode is configured by RRC or MAC-CE, or the one or more quasi co-location parameters are determined according to the transmission mode, a number of beam states, a number of beam states in the beam state group, or a number of beam state groups.

Clause 31. The method of wireless communication of clause 26, wherein the one or more quasi co-location parameters from the one or more beam states except for at least the first beam state of the beam states is ignored.

Clause 32. The method of wireless communication of clause 26, further comprising: activating one or more quasi co-location parameters for at least one of the one or more beam state by MAC-CE.

Clause 33. The method of wireless communication of any of clauses 29-32, wherein the one or more quasi co-location parameters comprise: Doppler shift, Doppler spread, average delay, delay spread, Doppler shift and Doppler spread, average delay and delay spread, Doppler shift and average delay, Doppler spread and delay spread, or Doppler shift, Doppler spread, average delay, delay spread.

Clause 34. The method of wireless communication of clause 26, wherein the UL signal comprises a UL channel, and wherein when the transmission mode is configured, a spatial relation of the UL channel is determined according to all or respective RSs in each of the one or more beam states, or a power control parameter of the UL channel is determined according to another power control parameter associated with at least one of the one or more beam states.

Clause 35. The method of wireless communication of clause 29 or 31, wherein the first beam state comprises a beam state with a lowest beam state identity or a highest beam state identity in a codepoint or a beam state group with a lowest beam state group identity or a highest beam state identity in the codepoint.

Clause 36. The method of wireless communication of clause 1, wherein a beam state indicated by the indication is associated with a PCI different from a serving cell PCI.

Clause 37. The method of wireless communication of clause 36, wherein a quasi co-location (QCL) of a downlink signal with a scheduled offset less than a threshold is determined according to quasi co-location (QCL) or a beam state of a CORESET associated with a monitored search space with a lowest CORESET ID in the latest slot in a carrier component (CC).

Clause 38. The method of wireless communication of clause 36, wherein a QCL-TypeA assumption in a CC of a CC list or a band is determined according to an RS in a first CC and having a same resource identity as the RS with regard to a QCL-TypeA or a QCL-TypeD in the CC with a lowest identity in the CC list or the band, or a QCL-TypeC assumption in the CC of the CC list or the band is determined according to the RS with regard to the QCL-TypeA in the CC with lowest identity in the CC list or the band.

Clause 39. The method of wireless communication of clause 38, wherein a QCL assumption is different in a time unit for different CCs.

Clause 40. The method of wireless communication of clause 36, wherein a QCL assumption of a DL signal with a scheduled offset less than a threshold is determined according to a CORESET associated with a monitored search space with the lowest CORESET identity in a latest slot in a CC with lowest identity.

Clause 41. The method of wireless communication of clause 36, wherein a QCL-assumption of a DL signal with scheduled offset less than a threshold is determined according to a RS corresponding to CORESET associated with a monitored search space with the lowest CORESET identity in the latest slot in the CC with a lowest ID.

Clause 42. The method of wireless communication of clause 40 or clause 41, wherein QCL assumption comprises a QCL-TypeA and a QCL-TypeD.

Clause 43. The method of wireless communication of clause 40 or clause 41, wherein the CC with the lowest identify comprises the CC with the lowest identify from a CC list or a band corresponding to the CC carrying the DL signal, or the CC with the lowest identify from a CC list or a band corresponding to the scheduling CC.

Clause 44. The method of wireless communication of clause 37, wherein the DL signals comprise at least one of a shared channel or an aperiodic CSI-RS.

Clause 45. A method of wireless communication, comprising: transmitting, from a network node, an indication of a plurality of beam states, wherein a wireless device performs, using the indication, a communication operation.

Clause 46. The method of clause 45, wherein the communication operation comprises determining a spatial filter or a power control parameter for an uplink (UL) signal from the wireless device to the network device according to one or more of the plurality of beam states.

Clause 47. The method of clauses 45, wherein an association parameter is configured for the DL signal or the UL signal to select the one or more of the plurality of beam states, or wherein one or more of plurality of beam states are selected for the DL signal or UL signal according to an indication in the DCI or MAC-CE.

Clause 48. A wireless communication apparatus, comprising a processor configured to implement a method recited in any one or more of clauses 1 to 47.

Clause 49. A computer program product having code stored thereon, the code, when executed by a processor, causing the processor to implement a method recited in any one or more of clauses 1 to 47.

From the foregoing, it will be appreciated that specific embodiments of the presently disclosed technology have been described herein for purposes of illustration, but that various modifications may be made without deviating from the scope of the invention. Accordingly, the presently disclosed technology is not limited except as by the appended claims.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

What is claimed is:

1. A method of wireless communication, comprising:
receiving, at a wireless device, an indication of a plurality of beam states; and
performing, using the indication, a communication operation by the wireless device.

2. The method of claim 1, further comprising:
configuring an association parameter, for a downlink (DL) signal or an uplink (UL) signal, to select the one or more of the plurality of beam states; or
selecting one or more of plurality of beam states for the DL signal or UL signal according to another indication in the DCI or MAC-CE.

3. The method of wireless communication of claim 2, wherein each association parameter includes at least one of:
no beam state,
a first beam state,
a second beam state, or
both the first beam state and the second beam states.

4. The method of wireless communication of claim 2,
wherein the DL signal comprises a PDCCH, and wherein the association parameter is configured per CORESET, or
wherein the DL signal comprises a shared channel, and wherein the association parameter is indicated by a field in the DCI scheduled the shared channel or initiated configured-grant in the shared channel.

5. The method of wireless communication of claim 2,
wherein the UL signal comprises a first-type configured-grant PUSCH, and wherein the association parameter is configured in a radio resource control (RRC) parameter, or
wherein the UL signal comprises a second-type configured-grant PUSCH, and wherein the association parameter is configured in a codepoint by a MAC-CE command or indicated in a field of the DCI, or
wherein the UL signal comprises a PUCCH, and wherein the association parameter is configured in a PUCCH resource or a PUCCH resource group.

6. The method of wireless communication of claim 2,
wherein the DL signal comprises a CSI-RS, or the UL signal comprises a sounding reference signal (SRS), and
wherein the association parameter is configured in a resource set, and
wherein the DL signal or UL signal is triggered by the DCI.

7. The method of wireless communication of claim 2, wherein two or more DL or UL signals are configured with a same association parameter or associated with a same beam state, and wherein the DL or UL signals are associated with a same group information parameter.

8. The method of wireless communication of claim 2, wherein the DL signal comprises the two or more CORESETs, wherein the CORESETs are configured with a same association parameter, and wherein the two or more CORESETs are associated with a same group information parameter.

9. The method of claim 1, further comprising:
associating a group information parameter with one or more beam states of the plurality of beam states;
associating a group information parameter with the DL or UL signals, wherein the one or more beam states is applied to DL or UL signals associated with the same group information parameter as the one or more beam states.

10. The method of wireless communication of claim 9,
wherein the plurality of beam states or beam state groups in a codepoint are associated with different or respective group information parameters, or
wherein the plurality of beam states comprises at least one beam state group, wherein the one or more beam states in the beam state group are applied to the DL or UL signals, or one demodulation reference signal (DMRS) ports of the DL or UL signals.

11. The method of wireless communication of claim 9, wherein the group information parameter comprises at least one of:
a CORESET group information identity, or
a control resource set (CORESET) pool identity.

12. The method of wireless communication of claim 10,
wherein the DL signal comprises a DL channel, and wherein the DL channel or DMRS of the DL channel is quasi co-located with RSs of the one or more beam states except for one or more quasi co-location parameters of at least a first beam state of the one or more beam states, and
wherein the one or more quasi co-location parameters comprise a Doppler shift and a Doppler spread.

13. The method of wireless communication of claim 10, wherein
a transmission mode is configured by RRC, or
the one or more quasi co-location parameters are determined according to the transmission mode, or a number of beam states, and
wherein the one or more quasi co-location parameters comprise a Doppler shift and a Doppler spread.

14. The method of wireless communication of claim 10, wherein the UL signal comprises a UL channel, and wherein a spatial relation of the UL channel is determined according to all or respective RSs in each of the one or more beam states.

15. The method of wireless communication of claim 1,
wherein a beam state indicated by the indication is associated with a PCI different from a serving cell PCI,
wherein a quasi co-location (QCL) of a downlink signal with a scheduled offset less than a threshold is determined according to quasi co-location (QCL) or a beam state of a CORESET associated with a monitored search space with a lowest CORESET ID in the latest slot in a carrier component (CC), and
wherein the DL signals comprise at least one of a shared channel or an aperiodic CSI-RS.

16. A wireless communication apparatus, comprising a processor configured to implement a method, the processor configured to:
receive, at a wireless device, an indication of a plurality of beam states; and
perform, using the indication, a communication operation by the wireless device.

17. The wireless communication apparatus of claim 16, wherein the processor is further configured to:
configure an association parameter, for a downlink (DL) signal or an uplink (UL) signal, to select the one or more of the plurality of beam states; or
select one or more of plurality of beam states for the DL signal or UL signal according to another indication in the DCI or MAC-CE.

18. The wireless communication apparatus of claim 17, wherein each association parameter includes at least one of:
no beam state,
a first beam state,
a second beam state, or
both the first beam state and the second beam states.

19. The wireless communication apparatus of claim 17,
wherein the DL signal comprises a PDCCH, and wherein the association parameter is configured per CORESET, or
wherein the DL signal comprises a shared channel, and wherein the association parameter is indicated by a field in the DCI scheduled the shared channel or initiated configured-grant in the shared channel.

20. The wireless communication apparatus of claim 17,
wherein the UL signal comprises a first-type configured-grant PUSCH, and wherein the association parameter is configured in a radio resource control (RRC) parameter, or
wherein the UL signal comprises a second-type configured-grant PUSCH, and wherein the association parameter is configured in a codepoint by a MAC-CE command or indicated in a field of the DCI, or
wherein the UL signal comprises a PUCCH, and wherein the association parameter is configured in a PUCCH resource or a PUCCH resource group.
